(19) United States
(12) Patent Application Publication
(10) Pub. No.: US 2025/0382164 A1
(43) Pub. Date: Dec. 18, 2025

(54) Transport Vehicle

(71) Applicant: Daifuku Co., Ltd., Osaka-shi (JP)

(72) Inventor: Daiki Takagi, Hinocho (JP)

(21) Appl. No.: 19/234,452

(22) Filed: Jun. 11, 2025

(30) Foreign Application Priority Data
Jun. 12, 2024 (JP) 2024-095275

(51) Int. Cl. B66F 9/06; B66F 9/075

(52) U.S. Cl. CPC B66F 9/063; B66F 9/07531

(57) ABSTRACT

Multiple wheels include at least one drive wheel drivable by a drive source. A body frame includes first and second frames aligned in a front-rear direction. A transport vehicle includes a first connector connecting the first frame to the second frame to allow the frames to swing about a first swing axis extending in a width direction, a second connector connecting the first frame to the support frame to allow the frames to swing about a second swing axis extending in the width direction, and a third connector connecting the second frame to the support frame to allow the frames to swing about a third swing axis extending in the width direction and to slide in the front-rear direction. A power storage unit is supported by the support frame attachably to and detachably from the support frame from a first side in the front-rear direction or in the width direction.

### CROSS-REFERENCE TO RELATED APPLICATION

This application claims priority to Japanese Patent Application No. 2024-095275 filed Jun. 12, 2024, the disclosure of which is hereby incorporated by reference in its entirety.

### BACKGROUND OF THE INVENTION

### Field of the Invention

The present invention relates to a transport vehicle including a body frame, multiple wheels supported by the body frame, a support frame connected to the body frame to support a transport object above the body frame, and a power storage unit storing power to be supplied to an in-vehicle device.

### Description of Related Art

An example of such a transport vehicle is described in Japanese Unexamined Patent Application Publication No. 2020-19348 (hereafter, JP 2020-19348). In the background described hereafter, reference signs in parentheses are the reference signs in JP 2020-19348.

In a transport vehicle (100) described in JP 2020-19348, power stored in a power storage unit (102) is supplied to a drive source (106), which then drives drive wheels (108) included in multiple wheels.

The transport vehicle (100) described in JP 2020-19348 undergoes maintenance such as replacement of the power storage unit (102) or inspection of a controller unit (101, 103) for controlling in-vehicle devices such as the drive source (106). Such maintenance of the power storage unit (102) and the controller unit (101, 103) can be complicated depending on their installation positions.

### SUMMARY OF THE INVENTION

Transport vehicles with structures that allow easy maintenance are awaited.

In response to the above, a transport vehicle includes a body frame, a plurality of wheels, a support frame, a power storage unit, a first connector, at least one second connector, and at least one third connector. The body frame includes a first frame and a second frame aligned in a front-rear direction. The plurality of wheels are supported by the body frame. The plurality of wheels include at least one drive wheel drivable by a drive source. The support frame is connected to the body frame to support a transport object above the body frame. The power storage unit stores power to be supplied to an in-vehicle device. The first connector connects the first frame to the second frame to allow the first frame and the second frame to swing about a first swing axis extending in a width direction. The width direction extends along a drive axis that is a rotation axis of the at least one drive wheel. The front-rear direction is perpendicular to the drive axis as viewed in a vertical direction. The at least one second connector connects the first frame to the support frame to allow the first frame and the support frame to swing about a second swing axis extending in the width direction. The at least one third connector connects the second frame to the support frame to allow the second frame and the support frame to swing about a third swing axis extending in the width direction and to slide in the front-rear direction. The power storage unit is supported by the support frame in a manner attachable to and detachable from the support frame from a first side in the front-rear direction or from a first side in the width direction.

In this structure, the power storage unit is supported by the support frame in a manner attachable to and detachable from the support frame, which is disposed above the body frame, from the first side in the front-rear direction or from the first side in the width direction. This structure allows relatively easy maintenance such as easy replacement of the power storage unit. The transport vehicle with the above structure thus allows easy maintenance.

### BRIEF DESCRIPTION OF THE DRAWINGS

FIG. 1 is a perspective view of a transport vehicle according to an embodiment.

FIG. 2 is a partial perspective view of the transport vehicle according to the embodiment.

FIG. 3 is a perspective view of first connectors in the transport vehicle according to the embodiment.

FIG. 4 is a perspective view of second connectors and third connectors in the transport vehicle according to the embodiment.

FIG. 5 is a partial side view of the transport vehicle according to the embodiment.

FIG. 6 is a partial side view of the transport vehicle according to the embodiment.

FIG. 7 is a view of a power storage unit in a closed state.

FIG. 8 is a view of the power storage unit in an open state.

FIG. 9 is a partial plan view of the transport vehicle according to the embodiment.

FIG. 10 is a perspective view of follower wheels in the transport vehicle according to the embodiment.

### DESCRIPTION OF THE INVENTION

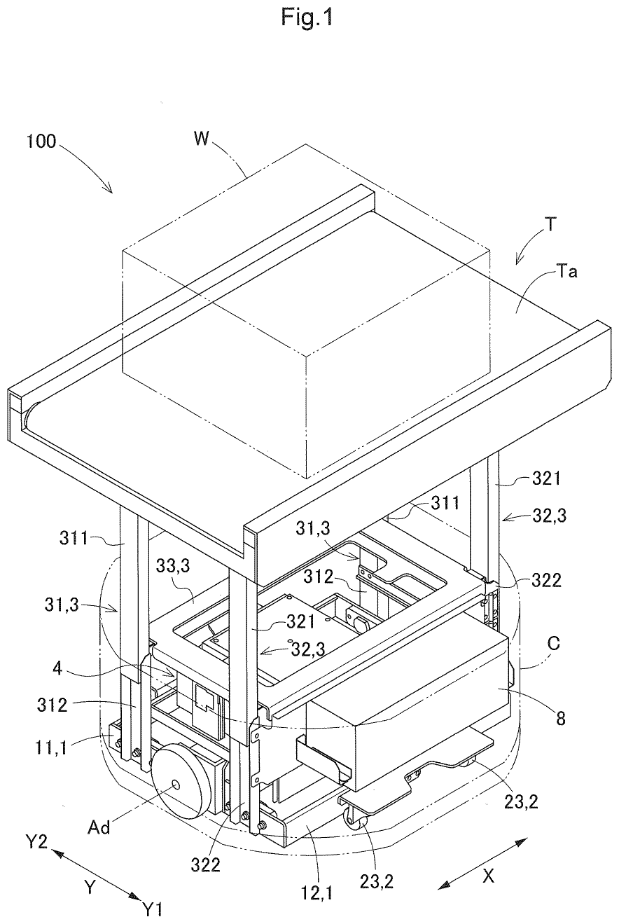

A transport vehicle 100 according to one or more embodiments will now be described with reference to the drawings. As shown in FIG. 1, the transport vehicle 100 includes a body frame 1, multiple wheels 2, a support frame 3, and a power storage unit 8. In the present embodiment, the transport vehicle 100 further includes a controller unit 4. The body frame 1, the wheels 2, a portion of the support frame 3, the controller unit 4, and the power storage unit 8 are covered with a cover C.

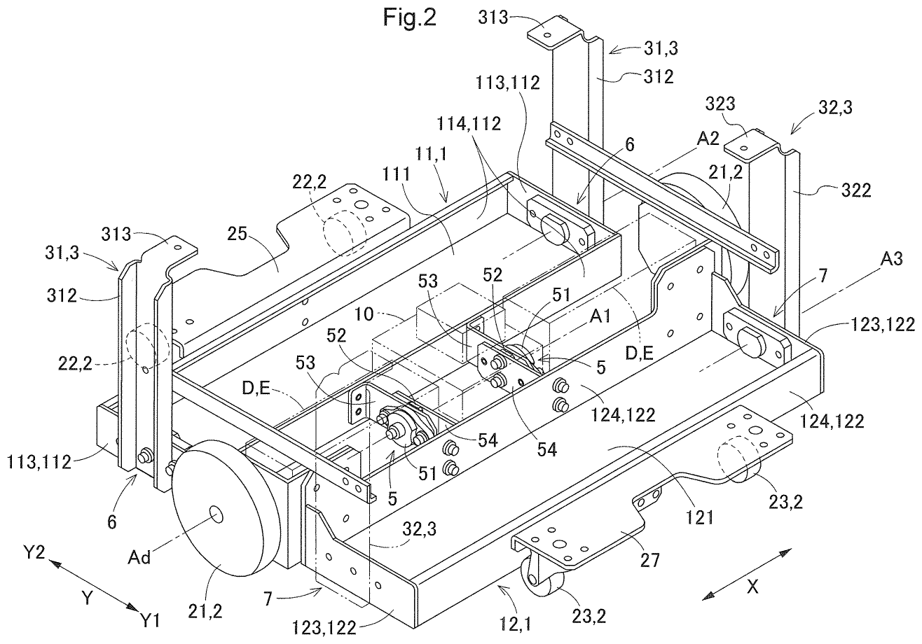

As shown in FIG. 2, the wheels 2 include at least one drive wheel 21 drivable by a drive source D. In the present embodiment, the wheels 2 include a pair of drive wheels 21, a pair of first follower wheels 22, and a pair of second follower wheels 23. In the present embodiment, the drive source D is an electric motor.

The direction along a drive axis Ad that is the rotation axis of the drive wheels 21 is hereafter referred to as a width direction X. The direction perpendicular to the drive axis Ad as viewed in the vertical direction is referred to as a front-rear direction Y. A first side in the front-rear direction Y is referred to as a front side Y1, and a second side in the front-rear direction Y is referred to as a rear side Y2. The vertical direction herein refers to the direction of gravity when the transport vehicle 100 is disposed on a horizontal plane. Extending in a reference direction or along an axis herein includes being parallel to the reference direction or the axis and slightly tilting (e.g., ±20°) relative to the reference direction or the axis.

The body frame 1 includes a first frame 11 and a second frame 12. The first frame 11 and the second frame 12 are aligned in the front-rear direction Y. In the present embodiment, the first frame 11 is disposed on the rear side Y2 relative to the second frame 12.

In the present embodiment, the first frame 11 and the second frame 12 are each in the form of a box with the upper surface being open. The first frame 11 includes a first bottom plate 111 in the form of a flat plate and first side plates 112 extending upward from the outer edges of the first bottom plate 111. The second frame 12 includes a second bottom plate 121 in the form of a flat plate and second side plates 122 extending upward from the outer edges of the second bottom plate 121.

In the present embodiment, the first bottom plate 111 is rectangular as viewed in the vertical direction with the sides extending in the width direction X being long sides and the sides extending in the front-rear direction Y being short sides. The first side plates 112 include a pair of first short surfaces 113 facing each other in the width direction X and a pair of first long surfaces 114 facing each other in the front-rear direction Y.

In the present embodiment, the second bottom plate 121 is rectangular as viewed in the vertical direction with the sides extending in the width direction X being long sides and the sides extending in the front-rear direction Y being short sides. The second side plates 122 include a pair of second short surfaces 123 facing each other in the width direction X and a pair of second long surfaces 124 facing each other in the front-rear direction Y.

As shown in FIG. 1, the support frame 3 is connected to the body frame 1. The support frame 3 supports a transport object W above the body frame 1. In the present embodiment, the support frame 3 supports, from below, a transferrer T that transfers the transport object W to a predetermined position. The transferrer T includes a mount Ta on which the transport object W is placeable. In the present embodiment, the mount Ta includes a conveyor belt that transports the receiving transport object W in the width direction X.

In the present embodiment, as shown in FIGS. 1 and 2, the support frame 3 includes a pair of first posts 31 and a pair of second posts 32.

The pair of first posts 31 extend upward from the first frame 11. The pair of first posts 31 are spaced from each other in the width direction X. In the present embodiment, each of the pair of first posts 31 includes a first upper post 311 and a first lower post 312. The first upper post 311 and the first lower post 312 are fixed to each other with the first upper post 311 extending upward from the first lower post 312. The first upper post 311 is connected to the transferrer T to support the transferrer T from below. The first lower post 312 is connected to one of the first short surfaces 113 of the first frame 11 on the side opposite the other first short surface 113 in the width direction X.

The pair of second posts 32 extend upward from the second frame 12. The pair of second posts 32 are spaced from each other in the width direction X. In the present embodiment, each of the pair of second posts 32 includes a second upper post 321 and a second lower post 322. The second upper post 321 and the second lower post 322 are fixed to each other with the second upper post 321 extending upward from the second lower post 322. The second upper post 321 is connected to the transferrer T to support the transferrer T from below. The second lower post 322 is connected to one of the second short surfaces 123 of the second frame 12 on the side opposite the other second short surface 123 in the width direction X.

The controller unit 4 controls in-vehicle devices E. The power storage unit 8 stores power to be supplied to the in-vehicle devices E. In the present embodiment, the power storage unit 8 also supplies power to the controller unit 4. In the present embodiment, the in-vehicle devices E include drive sources D, a drive source for the transferrer T, and various sensors. The control targets controlled by the controller unit 4 and the supply targets to which power is supplied by the power storage unit 8 may be some devices in the in-vehicle devices E or may be all the devices in the in-vehicle device E.

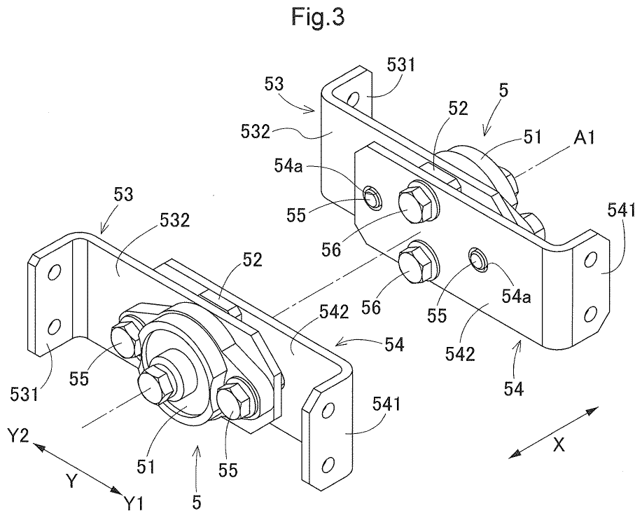

As shown in FIGS. 2 and 3, the transport vehicle 100 includes first connectors 5. The first connectors 5 connect the first frame 11 to the second frame 12 to allow the first frame 11 and the second frame 12 to swing about a first swing axis A1 extending in the width direction X. In the present embodiment, the first connectors 5 as a pair are aligned in the width direction X. In the present embodiment, each first connector 5 includes a first connector element 51 and a second connector element 52 that are swingable relative to each other about the first swing axis A1. In the present embodiment, the first swing axis A1 is near the drive axis Ad and is different from the drive axis Ad.

Each first connector element 51 is connected to the first frame 11 with a first joint 53 between them. The first joint 53 includes a first fixer 531 fixed to the first frame 11 and a first receiver 532 to which the first connector element 51 is attached.

The first fixer 531 is in the form of a plate perpendicular to the front-rear direction Y. The first fixer 531 is fastened to the first long surface 114 of the first frame 11 on the front side Y1 with bolts from the front side Y1.

The first receiver 532 is in the form of a plate perpendicular to the width direction X. The first connector element 51 is fastened to the first receiver 532 with bolts. In the present embodiment, the first connector element 51 in one of the first connectors 5 is attached to the first receiver 532 on the side opposite the other first connector 5 in the width direction X. The first connector element 51 and the first receiver 532 are fastened together with first bolts 55 with the head of each first bolt 55 adjacent to the first connector element 51. In the illustrated example, the first bolts 55 as a pair are arranged on both sides of the first swing axis A1 in the front-rear direction Y.

Each second connector element 52 is connected to the second frame 12 with a second joint 54 between them. The second joint 54 includes a second fixer 541 fixed to the second frame 12 and a second receiver 542 to which the second connector element 52 is attached.

The second fixer 541 is in the form of a plate perpendicular to the front-rear direction Y. The second fixer 541 is fastened to the second long surface 124 of the second frame 12 on the rear side Y2 with bolts from the rear side Y2.

The second receiver 542 is in the form of a plate perpendicular to the width direction X. The second connector element 52 is fastened to the second receiver 542 with bolts. In the present embodiment, the second connector element 52 in one of the first connectors 5 is attached to the second receiver 542 on the side opposite the other first connector 5 in the width direction X. The second connector element 52 is also attached to the first receiver 532, to which the first connector element 51 in one of the first connectors 5 is attached, on the same side as the other first connector 5 in the width direction X. In other words, the second connector element 52 is disposed between the second receiver 542 and the first receiver 532 in the width direction X in the present embodiment. The second connector element 52 and the second receiver 542 are fastened together with second bolts 56 with the head of each second bolt 56 on the second receiver 542. In the illustrated example, the second bolts 56 as a pair are arranged on both sides of the first swing axis A in the vertical direction.

In the present embodiment, as shown in FIG. 3, the second receiver 542 has through-holes 54a each receiving a threaded portion of the corresponding first bolt 55 extending in the width direction X. Each through-hole 54a has an inner diameter larger than the outer diameter of the threaded portion of the first bolt 55. This structure allows the threaded portion of each first bolt 55 to come in contact with the inner circumferential surface of the corresponding through-hole 54a, thus allowing the first connector element 51 and the second connector elements 52 to swing relative to each other in a restricted range. The first bolts 55 and the through-holes 54a can thus function as a restrictor that restricts swingable range of the first connector element 51 and the second connector element 52, eliminating a use of a separate dedicated restrictor in each first connector 5.

As shown in FIG. 2, the transport vehicle 100 includes second connectors 6 and third connectors 7.

The second connectors 6 connect the first frame 11 to the support frame 3 to allow the first frame 11 and the support frame 3 to swing about a second swing axis A2 extending in the width direction X. In the present embodiment, the second connectors 6 connect the first frame 11 to the first lower posts 312 in the first posts 31 in the support frame 3 to allow the first frame 11 and the first lower posts 312 to swing about the second swing axis A2. In the present embodiment, the second connectors 6 as a pair corresponding to the pair of first posts 31 are spaced from each other in the width direction X.

The third connectors 7 connect the second frame 12 to the support frame 3 to allow the second frame 12 and the support frame 3 to swing about a third swing axis A3 extending in the width direction X and to slide in the front-rear direction Y. In the present embodiment, the third connectors 7 connect the second frame 12 to the second lower posts 322 in the second posts 32 in the support frame 3 to allow the second frame 12 and the second lower posts 322 to swing about the third swing axis A3 and to slide in the front-rear direction Y. In the present embodiment, the third connectors 7 as a pair corresponding to the pair of second posts 32 are spaced from each other in the width direction X. The pair of third connectors 7 are arranged on the front side Y1 relative to the pair of second connectors 6.

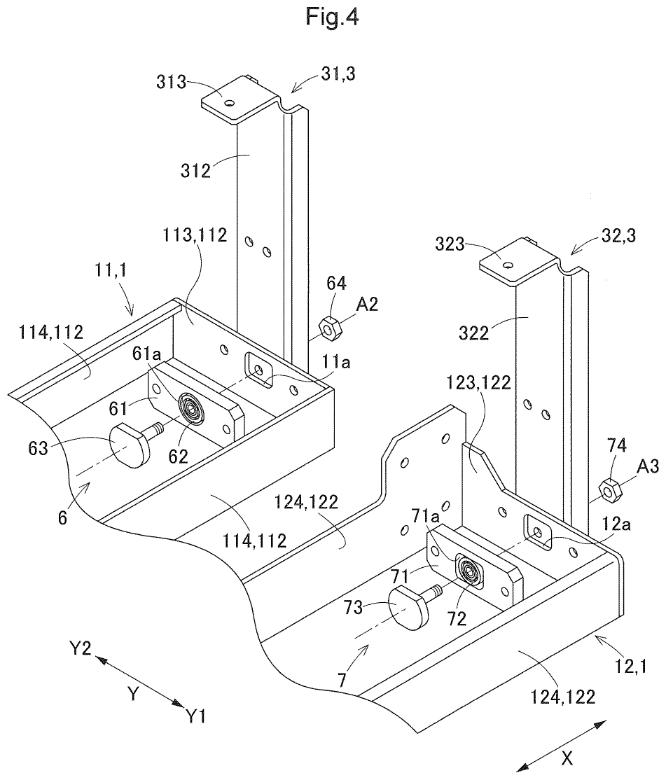

In the present embodiment, as shown in FIG. 4, each second connector 6 includes a second holder 61, a second bearing 62, a second connecting bolt 63, and a second connecting nut 64.

The second holder 61 holds the second bearing 62 while restricting relative movement of the second bearing 62 in the direction perpendicular to the second swing axis A2. The second holder 61 has a second holding hole 61a holding the second bearing 62. The second holding hole 61a has the same shape as the second bearing 62 to restrict relative movement of the second bearing 62 in the direction perpendicular to the second swing axis A2. The second holding hole 61a extends through the second holder 61 in the width direction X.

In the present embodiment, the second holder 61 is in the form of a plate perpendicular to the width direction X. The second holder 61 is fixed to the corresponding first short surface 113 of the first frame 11 on the side opposite the first post 31 in the width direction X.

The second bearing 62 is centered at the second swing axis A2. The second bearing 62 is a radial bearing. In the present embodiment, a first through-hole 11a having the same dimension as or a larger dimension than, in the direction perpendicular to the second swing axis A2, the second holding hole 61a extends through the first short surface 113 of the first frame 11 in the width direction X. The second bearing 62 is received in both the first through-hole 11a and the second holding hole 61a.

The second connecting bolt 63 and the second connecting nut 64 connect the second bearing 62 and the first post 31 to the first frame 11. In the present embodiment, the second bearing 62 is received in the first through-hole 11a and the second holding hole 61a. The second connecting bolt 63 is placed through the second bearing 62 and the first lower post 312 in the first post 31 with the first lower post 312 in contact with the corresponding first short surface 113 of the first frame 11. The second connecting nut 64 is screwed on the threaded portion on the distal end of the second connecting bolt 63.

In the present embodiment, each third connector 7 includes a third holder 71, a third bearing 72, a third connecting bolt 73, and a third connecting nut 74.

The third holder 71 holds the third bearing 72 to allow relative movement of the third bearing 72 in the front-rear direction Y in a predetermined range while restricting relative movement of the third bearing 72 in the vertical direction. The third holder 71 has a third holding hole 71a holding the third bearing 72. The third holding hole 71a is an elongated hole having the shape of the third bearing 72 elongated in the front-rear direction Y to allow relative movement of the third bearing 72 in a predetermined range in the front-rear direction Y while restricting relative movement of the third bearing 72 in the vertical direction. The third holding hole 71a extends through the third holder 71 in the width direction X.

In the present embodiment, the third holder 71 is in the form of a plate extending perpendicular to the width direction X. The third holder 71 is fixed to the corresponding second short surface 123 of the second frame 12 on the side opposite the second post 32 in the width direction X.

The third bearing 72 is centered at the third swing axis A3. The third bearing 72 is a radial bearing. In the present embodiment, a second through-hole 12a having the same dimension as or a larger dimension than, in the direction perpendicular to the third swing axis A3, the third holding hole 71a extends through the second short surface 123 of the second frame 12 in the width direction X. The third bearing 72 is received in both the second through-hole 12a and the third holding hole 71a.

The third connecting bolt 73 and the third connecting nut 74 connect the third bearing 72 and the second post 32 to the second frame 12. In the present embodiment, the third bearing 72 is received in the second through-hole 12a and the third holding hole 71a. The third connecting bolt 73 is placed through the third bearing 72 and the second lower post 322 in the second post 32 with the second lower post 322 in contact with the corresponding second short surface 123 of the second frame 12. The third connecting nut 74 is screwed on the threaded portion on the distal end of the third connecting bolt 73.

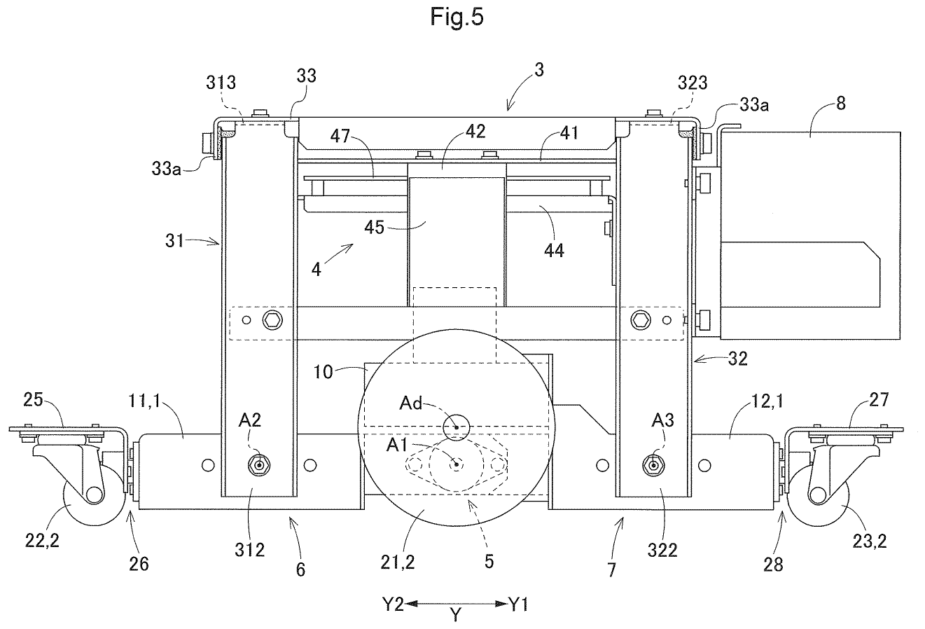

In the present embodiment, as shown in FIGS. 1 and 5, the support frame 3 includes a support 33.

The support 33 is connected to the pair of first posts 31 and the pair of second posts 32. The support 33 is disposed above the second connectors 6 and the third connectors 7. In the present embodiment, the support 33 is in the form of a plate perpendicular to the vertical direction.

The controller unit 4 is supported by the support 33. In the present embodiment, the controller unit 4 is supported by and hung from the support 33.

The controller unit 4 is at least partially surrounded by the support frame 3 as viewed in the vertical direction. In the present embodiment, the controller unit 4 is fully disposed in an area surrounded by the pair of first posts 31 and the pair of second posts 32 as viewed in the vertical direction.

In the present embodiment, as shown in FIGS. 2 and 5, the first lower post 312 in each first post 31 includes a first mount 313. The pair of first mounts 313 are each in the form of a plate perpendicular to the vertical direction. The pair of first mounts 313 extend from the upper ends of the pair of first lower posts 312 toward each other in the width direction X.

In the present embodiment, the second lower post 322 in each second post 32 includes a second mount 323. The pair of second mounts 323 are each in the form of a plate perpendicular to the vertical direction. The pair of second mounts 323 extend from the upper ends of the pair of second lower posts 322 toward each other in the width direction X.

In the present embodiment, as shown in FIG. 5, the support 33 is placed on and fixed to the pair of first mounts 313 and the pair of second mounts 323.

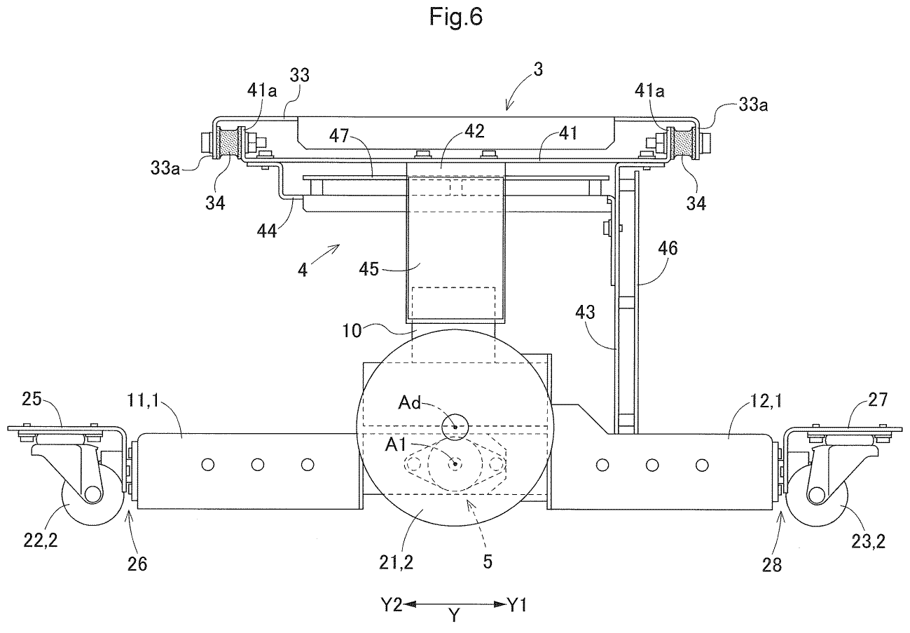

In the present embodiment, as shown in FIG. 6, the controller unit 4 includes a first hanger 41, a second hanger 42, a third hanger 43, a fourth hanger 44, a first substrate 45, a second substrate 46, and a third substrate 47.

The first hanger 41 is supported by and hung from the support 33. The first hanger 41 is in the form of a plate perpendicular to the vertical direction. In the present embodiment, the first hanger 41 is connected to the support 33 with an elastic member 34 between them for vibration isolation. The elastic member 34 may be, for example, a rubber piece, a urethane piece, or a spring.

In the present embodiment, the first hanger 41 includes a pair of upward portions 41a extending upward from both ends of the first hanger 41 in the front-rear direction Y. The support 33 includes a pair of downward portions 33a extending downward from both ends of the support 33 in the front-rear direction Y.

In the present embodiment, the downward portion 33a on the front side Y1 is disposed on the front side Y1 relative to the upward portion 41a on the front side Y1. The downward portion 33a on the front side Y1 and the upward portion 41a on the front side Y1 are connected to each other with the elastic member 34 between them in the front-rear direction Y. Multiple elastic members 34 may be arranged in the width direction X between the downward portion 33a on the front side Y1 and the upward portion 41a on the front side Y1 in the front-rear direction Y.

In the present embodiment, the downward portion 33a on the rear side Y2 is disposed on the rear side Y2 relative to the upward portion 41a on the rear side Y2. The downward portion 33a on the rear side Y2 and the upward portion 41a on the rear side Y2 are connected to each other with the elastic member 34 between them in the front-rear direction Y. Multiple elastic members 34 may be arranged in the width direction X between the downward portion 33a on the rear side Y2 and the upward portion 41a on the rear side Y2 in the front-rear direction Y.

The second hanger 42 is supported by and hung from the first hanger 41. The second hanger 42 is in the form of a plate perpendicular to the width direction X. The second hanger 42 supports the first substrate 45 from a first side in the width direction X. In the present embodiment, the second hanger 42 is fixed to a middle portion of the first hanger 41 in the front-rear direction Y from below.

The third hanger 43 is supported by and hung from the first hanger 41. The third hanger 43 is in the form of a plate perpendicular to the front-rear direction Y. The third hanger 43 supports the second substrate 46 from the rear side Y2. In the present embodiment, the third hanger 43 is fixed to the first hanger 41 from below on the front side Y1 relative to the second hanger 42.

The fourth hanger 44 is supported by and hung from the first hanger 41. The fourth hanger 44 is in the form of a plate perpendicular to the vertical direction. The fourth hanger 44 supports the third substrate 47 from below. In the present embodiment, the fourth hanger 44 is fixed to the first hanger 41 from below on the rear side Y2 relative to the second hanger 42 and is fixed to the third hanger 43 from the rear side Y2 on the front side Y1 relative to the second hanger 42.

In the present embodiment, the controller unit 4 is thus connected to the support frame 3 with the elastic members 34 between them for vibration isolation.

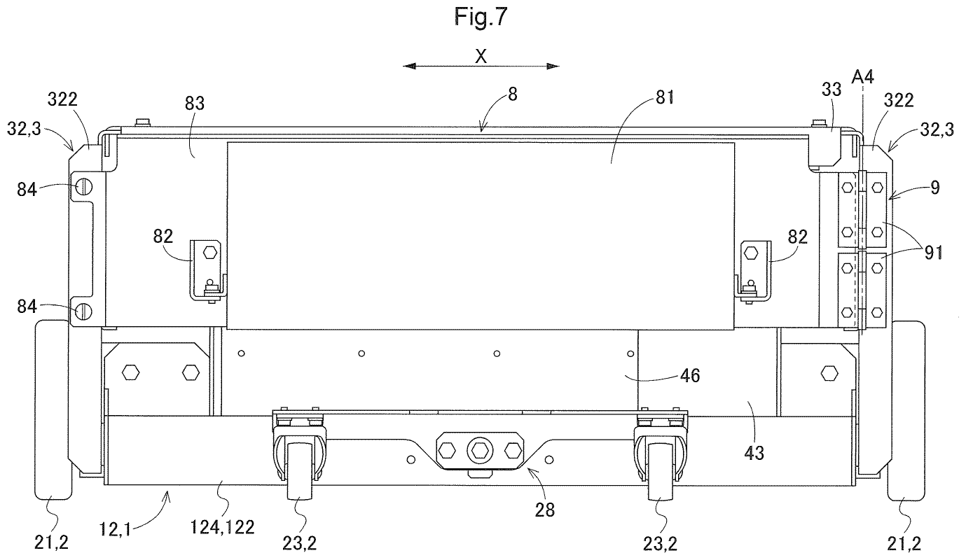

As shown in FIG. 7, the power storage unit 8 is supported by the support frame 3. In the present embodiment, the power storage unit 8 is supported by at least one post of the pair of first posts 31 or the pair of second posts 32.

The power storage unit 8 is attachable to and detachable from the support frame 3 from the first side in the front-rear direction Y or from the first side in the width direction X. In the present embodiment, the power storage unit 8 is attachable to and detachable from the support frame 3 from the front side Y1. A first element being attached to and detached from a second element herein includes, in addition to the first element being fully attached to and detached from the second element, a part of the first element being attached to and detached from the second element with another part of the first element in contact with or connected to the second element.

In the present embodiment, the power storage unit 8 includes a power storage 81, a pair of holders 82, and a door 83.

The power storage 81 is a battery storing power. The pair of holders 82 hold the power storage 81 from both sides in the width direction X. The pair of holders 82 are fixed to the door 83 from the front side Y1. More specifically, the power storage 81 is disposed on the front side Y1 relative to the door 83 and fixed to the door 83 with the pair of holders 82. The door 83 is in the form of a plate extending in the width direction X across the pair of second posts 32. The door 83 is disposed on the front side Y1 relative to the pair of second posts 32. In the present embodiment, the power storage unit 8 is fully disposed outside (on the front side Y1 in this example) the area surrounded by the pair of first posts 31 and the pair of second posts 32 as viewed in the vertical direction.

In the present embodiment, the transport vehicle 100 includes a fourth connector 9. The fourth connector 9 connects the power storage unit 8 to the support frame 3 to allow the power storage unit 8 to swing about a predetermined fourth swing axis A4. In the present embodiment, the fourth swing axis A4 is parallel to the vertical direction.

In the present embodiment, the fourth connector 9 includes a pair of hinges 91. The pair of hinges 91 are aligned in the vertical direction.

In the present embodiment, the door 83 is connected to the second lower post 322 in one of the second posts 32 (on the right in FIG. 7) with the pair of hinges 91 swingable about the fourth swing axis A4 relative to the second lower post 322 in the second post 32.

In the present embodiment, the door 83 is attachable to and detachable from the second lower post 322 in the other of the second posts 32 (on the left in FIG. 7) by fastening or loosening attachment bolts 84 at two positions aligned in the vertical direction.

The power storage unit 8 is disposed adjacent to the controller unit 4 on the first side in the front-rear direction Y or on the first side in the width direction X. The power storage unit 8 overlaps the controller unit 4 as viewed in the front-rear direction Y or in the width direction X. Two elements overlapping each other as viewed in a specific direction herein refers to an imaginary line parallel to a viewing direction at least partially intersecting with the two elements when the imaginary line is shifted to the directions perpendicular to the imaginary line.

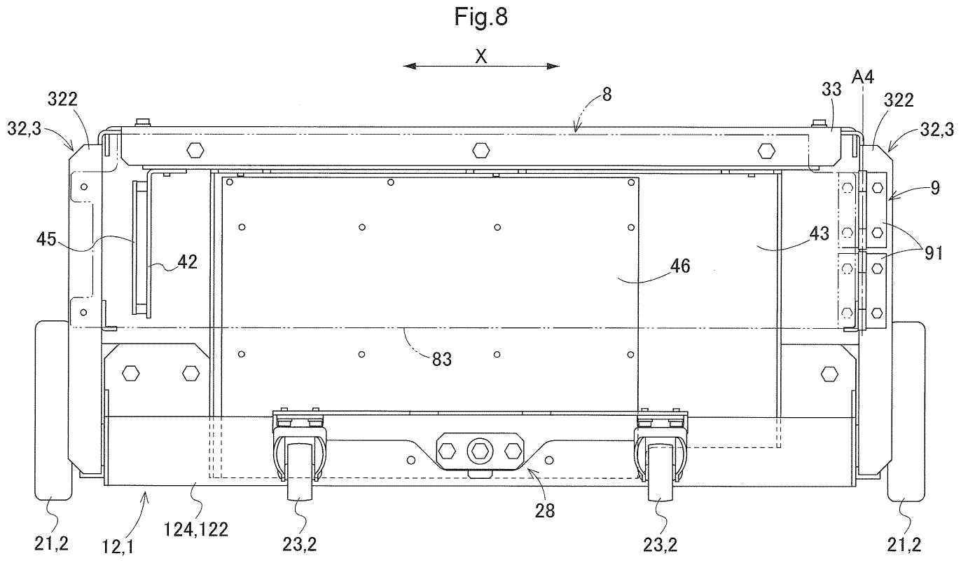

In the present embodiment, as shown in FIG. 8, the power storage unit 8 is disposed adjacent to the controller unit 4 on the front side Y1. The power storage unit 8 overlaps the controller unit 4 as viewed in the front-rear direction Y.

In the present embodiment, when the door 83 is connected to the other of the second lower posts 322 in the corresponding second post 32 (on the left in FIG. 7) with the pair of attachment bolts 84 (in a closed state), the second substrate 46 in the controller unit 4 is partially hidden by the door 83 as viewed from the front side Y1. When the door 83 is swung about the fourth swing axis A4 away from the other of the second lower posts 322 in the corresponding second post 32 (on the left in FIG. 7) with the pair of attachment bolts 84 removed, the operator can access the second substrate 46 in the controller unit 4 from the front side Y1 for inspection.

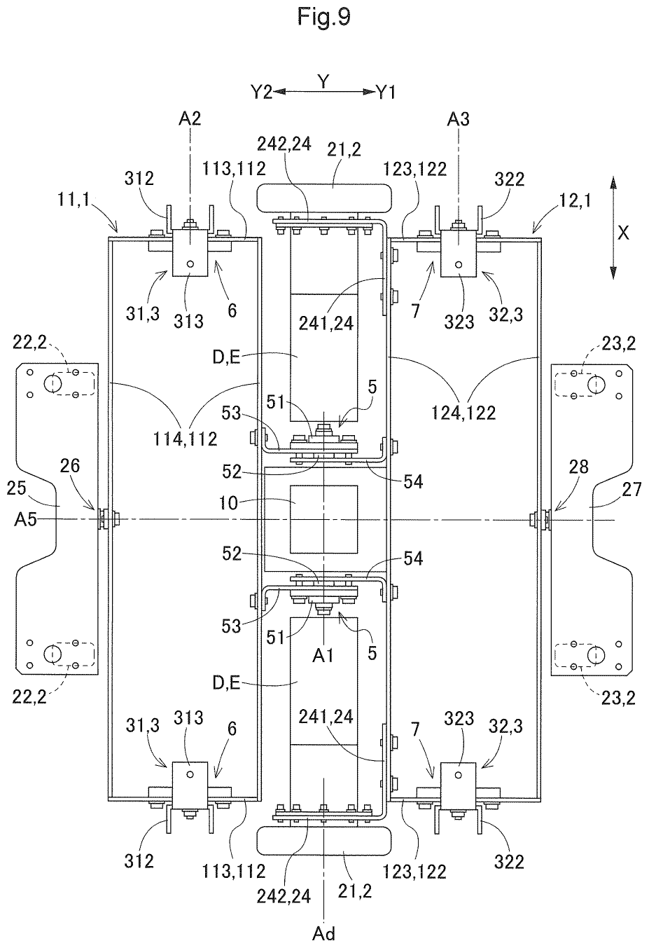

In the present embodiment, as shown in FIG. 9, the transport vehicle 100 further includes a reader 10. The reader 10 detects multiple position information holders (not shown) arranged on a surface on which the transport vehicle 100 travels and reads the position information held by the position information holders. In the present embodiment, the reader 10 is disposed between the pair of first connectors 5 in the width direction X. Each position information holder may be, for example, a bar code or a wireless tag. The reader 10 may be a bar code reader when the position information holder uses a bar code. The reader 10 may be a tag reader when the position information holder uses a wireless tag.

In the present embodiment, the pair of drive wheels 21 are arranged on both sides of the pair of first connectors 5 in the width direction X. Each of the pair of drive wheels 21 is attached to the second frame 12 with a third joint 24. The third joint 24 includes a third fixer 241 fixed to the second frame 12 and a third receiver 242 to which the corresponding drive wheel 21 is attached.

The third fixer 241 is in the form of a plate perpendicular to the front-rear direction Y. In the present embodiment, the third fixer 241 is fastened to the second long surface 124 of the second frame 12 on the rear side Y2 with bolts from the rear side Y2.

The third receiver 242 is in the form of a plate perpendicular to the width direction X. In the present embodiment, a first drive wheel 21 is disposed on the side opposite a second drive wheel 21 in the width direction X relative to the third receiver 242 to which the first drive wheel 21 is attached.

In the present embodiment, the drive source D for driving the first drive wheel 21 is attached to the third receiver 242 to extend from the third receiver 242, to which the first drive wheel 21 is attached, toward the second drive wheel 21 in the width direction X. Each of the pair of drive sources D is disposed between the first frame 11 and the second frame 12 in the front-rear direction Y and between the corresponding third receiver 242 and the corresponding first connector 5 in the width direction X.

In the present embodiment, the pair of first follower wheels 22 are arranged on both sides of a fifth swing axis A5 in the width direction X. The fifth swing axis A5 extends in the front-rear direction Y. The pair of first follower wheels 22 are attached to a first mount member 25. The first mount member 25 is attached to the first frame 11 with a first swing assembly 26 between them. The first swing assembly 26 connects the first mount member 25 to the first frame 11 to allow the first mount member 25 to swing about the fifth swing axis A5.

In the present embodiment, the pair of second follower wheels 23 are arranged on both sides of the fifth swing axis A5 in the width direction X. The pair of second follower wheels 23 are attached to a second mount member 27. The second mount member 27 is attached to the second frame 12 with a second swing assembly 28 between them. The second swing assembly 28 connects the second mount member 27 to the second frame 12 to allow the second mount member 27 to swing about the fifth swing axis A5.

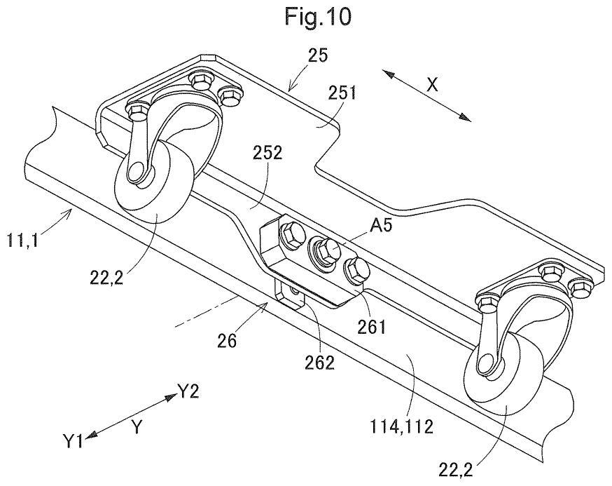

In the present embodiment, as shown in FIG. 10, the first mount member 25 includes a wheel support 251 and a swing connector 252.

The wheel support 251 supports the pair of first follower wheels 22. In the present embodiment, the wheel support 251 is in the form of a plate perpendicular to the vertical direction. The pair of first follower wheels 22 are arranged below the wheel support 251. In the present embodiment, each of the pair of first follower wheels 22 is supported in a manner rotatable about an axis extending in the vertical direction.

The swing connector 252 is connected to the first swing assembly 26. In the present embodiment, the swing connector 252 is in the form of a plate perpendicular to the front-rear direction Y. The swing connector 252 faces, from the rear side Y2, the first long surface 114 of the first frame 11 on the rear side Y2. In the present embodiment, the swing connector 252 extends downward from the end of the wheel support 251 on the front side Y1.

In the present embodiment, the first swing assembly 26 includes a first swing element 261 and a second swing element 262 that are swingable relative to each other about the fifth swing axis A5.

The first swing element 261 is fixed to the swing connector 252 in the first mount member 25. In the present embodiment, the first swing element 261 is disposed on the rear side Y2 relative to the swing connector 252.

The second swing element 262 is fixed to the first long surface 114 of the first frame 11 on the rear side Y2. In the present embodiment, the second swing element 262 is disposed on the rear side Y2 relative to the first long surface 114 on the rear side Y2 and is disposed on the front side Y1 relative to the swing connector 252. More specifically, the second swing element 262 is disposed between the first long surface 114 on the rear side Y2 and the swing connector 252 in the front-rear direction Y in the present embodiment.

The second mount member 27 has the same structure as the first mount member 25, and the second swing assembly 28 has the same structure as the first swing assembly 26. The second mount member 27 and the second swing assembly 28 thus will not be described in detail.

### Other Embodiments

(1) In the above embodiment, the power storage unit 8 is attachable to and detachable from the support frame 3 with the attachment bolts 84, while being connected to the support frame 3 with the fourth connector 9 in a manner swingable about the fourth swing axis A4. However, the structure is not limited to this example. For example, the structure may eliminate the power the fourth connector 9, and the storage unit 8 may be fully attachable to and detachable from the support frame 3 with the attachment bolts 84.

(2) In the above embodiment, the power storage 81 in the power storage unit 8 is a battery. However, the structure is not limited to this example. For example, the power storage 81 may be a capacitor.

(3) In the above embodiment, the fourth swing axis A4 is parallel to the vertical direction. However, the structure is not limited to this example. For example, the fourth swing axis A4 may be parallel to the horizontal direction.

(4) In the above embodiment, the door 83 is connected to the second lower post 322 in one of the second posts 32 (on the right in FIG. 7) with the pair of hinges 91, and is swingable to be closer to and away from the second lower post 322 in the other second post 32 (on the left in FIG. 7). In other words, the fourth swing axis A4, about which the door 83 is swingable, is near one of the second posts 32 (on the right in FIG. 7) to allow the door 83 to be open and closed from the side of the other second post 32 (on the left in FIG. 7). However, the structure is not limited to this example. For example, the fourth swing axis A4 may be near the other second post 32 (on the left in FIG. 7) to allow the door 83 to be open or closed from the side of one of the second posts 32 (on the right in FIG. 7). In some embodiments, the fourth swing axis A4 may be arranged near each of the second posts 32 to allow the door 83 to be open or closed on both sides in the width direction X.

(5) In the above embodiment, the power storage unit 8 is attachable to and detachable from the support frame 3 from the front side Y1. However, the structure is not limited to this example. The power storage unit 8 may be attachable to and detachable from the support frame 3 from the rear side Y2 or from the first side or the second side in the width direction X.

(6) In the above embodiment, the power storage unit 8 is disposed adjacent to the controller unit 4 on the front side Y1. However, the structure is not limited to this example. The power storage unit 8 may be disposed adjacent to the controller unit 4 on the rear side Y2 or on the first side or the second side in the width direction X. For the power storage unit 8 disposed adjacent to the controller unit 4 on the front side Y1 or on the rear side Y2, the power storage unit 8 may overlap the controller unit 4 as viewed in the front-rear direction Y. For the power storage unit 8 disposed adjacent to the controller unit 4 on the first side or the second side in the width direction X, the power storage unit 8 may overlap the controller unit 4 as viewed in the width direction X.

(7) In the above embodiment, the first frame 11 is disposed on the rear side Y2 relative to the second frame 12. However, the structure is not limited to this example. The first frame 11 may be disposed on the front side Y1 relative to the second frame 12.

(8) In the above embodiment, the multiple wheels 2 include the pair of drive wheels 21, the pair of first follower wheels 22, and the pair of second follower wheels 23. However, the structure is not limited to this example. The multiple wheels 2 may include, for example, one drive wheel 21 or three or more drive wheels 21. All the wheels 2 may be the drive wheels 21.

(9) In the above embodiment, the first swing axis A1 is eccentric from the drive axis Ad. However, the structure is not limited to this example. The first swing axis A1 may be coaxial with the drive axis Ad.

(10) In the above embodiment, the pair of second connectors 6 are spaced from each other in the width direction X, and the pair of third connectors 7 are spaced from each other in the width direction X. However, the structure is not limited to this example. The structure may include three or more second connectors 6 arranged in the width direction X, three or more third connectors 7 arranged in the width direction X, or both. The structure may include a single second connector 6, a single third connector 7, or both.

(11) The structure described in each of the above embodiments may be combined with any other structures described in the other embodiments unless any contradiction arises. The embodiments described herein are merely illustrative in all aspects and may be modified variously as appropriate without departing from the spirit and scope of the disclosure.

### Overview of Present Embodiment

The transport vehicle described above will now be described briefly.

A transport vehicle includes a body frame, a plurality of wheels, a support frame, a power storage unit, a first connector, at least one second connector, and at least one third connector. The body frame includes a first frame and a second frame aligned in a front-rear direction. The plurality of wheels are supported by the body frame. The plurality of wheels include at least one drive wheel drivable by a drive source. The support frame is connected to the body frame to support a transport object above the body frame. The power storage unit stores power to be supplied to an in-vehicle device. The first connector connects the first frame to the second frame to allow the first frame and the second frame to swing about a first swing axis extending in a width direction. The width direction extends along a drive axis that is a rotation axis of the at least one drive wheel. The front-rear direction is perpendicular to the drive axis as viewed in a vertical direction. The at least one second connector connects the first frame to the support frame to allow the first frame and the support frame to swing about a second swing axis extending in the width direction. The at least one third connector connects the second frame to the support frame to allow the second frame and the support frame to swing about a third swing axis extending in the width direction and to slide in the front-rear direction. The power storage unit is supported by the support frame in a manner attachable to and detachable from the support frame from a first side in the front-rear direction or from a first side in the width direction.

In this structure, the power storage unit is supported by the support frame in a manner attachable to and detachable from the support frame, which is disposed above the body frame, from the first side in the front-rear direction or from the first side in the width direction. This structure allows relatively easy maintenance such as easy replacement of the power storage unit. The transport vehicle with the above structure thus allows easy maintenance.

In this structure, the first frame is connected to the second frame with the first connector to allow the first frame and the second frame to swing about the first swing axis. The first frame is connected to the support frame with the second connector to allow the first frame and the support frame to swing about the second swing axis, and the second frame is connected to the support frame with the third connector to allow the second frame and the support frame to swing about the third swing axis. This structure allows the transport vehicle to travel appropriately with the drive wheels remaining in contact with the travel surface with any irregularities.

The transport vehicle may further include a controller unit that controls the in-vehicle device. The power storage unit may supply power to the controller unit. The controller unit may be at least partially surrounded by the support frame as viewed in the vertical direction. The power storage unit may be disposed adjacent to the controller unit on the first side in the front-rear direction or on the first side in the width direction.

This structure uses the spaces inside and outside the support frame to appropriately arrange and support the controller unit and the power storage unit with the support frame. Thus, the power storage unit and the controller unit can be appropriately installed in a limited space in the transport vehicle while allowing easy maintenance of the power storage unit.

In the above structure, the transport vehicle may further include a fourth connector connecting the power storage unit to the support frame to allow the power storage unit to swing about a predetermined fourth swing axis.

This structure allows the power storage unit to swing about the fourth swing axis for maintenance such as inspection of the controller unit, and thus allows easy access to the controller unit disposed inside the support frame relative the power storage unit without fully detaching the power storage unit from the support frame. This allows easy maintenance of the controller unit.

The support frame may include a pair of first posts spaced from each other in the width direction and extending upward from the first frame, a pair of second posts spaced from each other in the width direction and extending upward from the second frame, and a support connected to the pair of first posts and the pair of second posts. The at least one second connector may include a pair of second connectors connecting the first frame to the pair of first posts to allow the first frame and the pair of first posts to swing about the second swing axis. The at least one third connector may include a pair of third connectors connecting the second frame to the pair of second posts to allow the second frame and the pair of second posts to swing about the third swing axis and to slide in the front-rear direction. The controller unit may be supported by the support. The power storage unit may be supported by at least one post of the pair of first posts or the pair of second posts.

This structure includes the support connected to the pair of first posts and the pair of second posts both extending upward from the body frame, thus increasing the stiffness of the support frame. The controller unit is supported by the support, and the power storage unit is supported by at least one of the four posts. The controller unit and the power storage unit can thus be supported appropriately by the support frame.

In the above structure, the controller unit may be supported by and hung from the support. The power storage unit may overlap the controller unit as viewed in the front-rear direction or in the width direction.

This structure allows the controller unit to be stably supported by and hung from the support connected to the pair of first posts and the pair of second posts. The power storage unit overlaps the controller unit as viewed in the front-rear direction or in the width direction. The power storage unit can be detached from the support frame to allow easy access to the controller unit disposed inside the support frame relative to the power storage unit. The transport vehicle with this structure can have a smaller vertical dimension than a transport vehicle including the power storage unit not overlapping the controller unit in the front-rear direction or in the width direction.

### INDUSTRIAL APPLICABILITY

The technique according to one or more embodiments of the disclosure is usable for a transport vehicle including a body frame, multiple wheels supported by the body frame, a support frame connected to the body frame to support a transport object above the body frame, and a power storage unit that stores power to be supplied to an in-vehicle device.

What is claimed is:

1. A transport vehicle, comprising:
a body frame comprising a first frame and a second frame aligned in a front-rear direction;
a plurality of wheels supported by the body frame, the plurality of wheels comprising at least one drive wheel drivable by a drive source;
a support frame connected to the body frame to support a transport object above the body frame;
a power storage unit configured to store power to be supplied to an in-vehicle device;
a first connector connecting the first frame to the second frame to allow the first frame and the second frame to swing about a first swing axis extending in a width direction, the width direction extending along a drive axis that is a rotation axis of the at least one drive wheel, the front-rear direction being perpendicular to the drive axis as viewed in a vertical direction;
at least one second connector connecting the first frame to the support frame to allow the first frame and the support frame to swing about a second swing axis extending in the width direction; and
at least one third connector connecting the second frame to the support frame to allow the second frame and the support frame to swing about a third swing axis extending in the width direction and to slide in the front-rear direction, and
wherein the power storage unit is supported by the support frame in a manner attachable to and detachable from the support frame from a first side in the front-rear direction or from a first side in the width direction.

2. The transport vehicle according to claim 1, further comprising:
a controller unit configured to control the in-vehicle device,
wherein the power storage unit supplies power to the controller unit,
wherein the controller unit is at least partially surrounded by the support frame as viewed in the vertical direction, and
wherein the power storage unit is disposed adjacent to the controller unit on the first side in the front-rear direction or on the first side in the width direction.

3. The transport vehicle according to claim 2, further comprising:
a fourth connector connecting the power storage unit to the support frame to allow the power storage unit to swing about a predetermined fourth swing axis.

4. The transport vehicle according to claim 2, wherein:
the support frame comprises:
a pair of first posts spaced from each other in the width direction and extending upward from the first frame,
a pair of second posts spaced from each other in the width direction and extending upward from the second frame, and
a support connected to the pair of first posts and the pair of second posts,
the at least one second connector comprises a pair of second connectors connecting the first frame to the pair of first posts to allow the first frame and the pair of first posts to swing about the second swing axis,
the at least one third connector comprises a pair of third connectors connecting the second frame to the pair of second posts to allow the second frame and the pair of second posts to swing about the third swing axis and to slide in the front-rear direction,
the controller unit is supported by the support, and
the power storage unit is supported by at least one post of the pair of first posts or the pair of second posts.

5. The transport vehicle according to claim 4, wherein:
the controller unit is supported by and hung from the support, and
the power storage unit overlaps the controller unit as viewed in the front-rear direction or in the width direction.

6. The transport vehicle according to claim 3, wherein:
the support frame comprises
a pair of first posts spaced from each other in the width direction and extending upward from the first frame,
a pair of second posts spaced from each other in the width direction and extending upward from the second frame, and
a support connected to the pair of first posts and the pair of second posts,
the at least one second connector comprises a pair of second connectors connecting the first frame to the pair of first posts to allow the first frame and the pair of first posts to swing about the second swing axis,
the at least one third connector comprises a pair of third connectors connecting the second frame to the pair of second posts to allow the second frame and the pair of second posts to swing about the third swing axis and to slide in the front-rear direction,
the controller unit is supported by the support, and
the power storage unit is supported by at least one post of the pair of first posts or the pair of second posts.

7. The transport vehicle according to claim 6, wherein:
the controller unit is supported by and hung from the support, and
the power storage unit overlaps the controller unit as viewed in the front-rear direction or in the width direction.
